(19) United States
(12) Patent Application Publication
(10) Pub. No.: US 2025/0297334 A1
(43) Pub. Date: Sep. 25, 2025

(54) IRON PRODUCTION WITH SYNTHESIS GAS FEED AND CARBON CAPTURE

(71) Applicant: 8 Rivers Capital, LLC, Durham, NC (US)

(72) Inventors: Maulik R. Shelat, Macungie, PA (US); Yun Wu, Davidson, NC (US); Deng-Tung Wang, Durham, NC (US); Shankar Nataraj, Allentown, PA (US)

(21) Appl. No.: 19/083,887

(22) Filed: Mar. 19, 2025

Related U.S. Application Data
(60) Provisional application No. 63/567,184, filed on Mar. 19, 2024.

(51) Int. Cl. C21B 13/00; C01B 3/34

(52) U.S. Cl. CPC C21B 13/0073; C01B 3/34; C01B 2203/0233; C01B 2203/0833; C01B 2203/1235; C21B 2100/22

(57) ABSTRACT

The present disclosure provides systems and methods for iron production as well as apparatuses useful in such systems and methods. Metallic iron is produced in a DRI furnace into which is introduced raw iron (iron oxides) and a syngas. The syngas is formed using a first processing unit, such as a CO₂ convective reformer (CCR), and optionally a second processing unit, such as an oxygen secondary reformer (OSR), to react a hydrocarbon with a reformant to form syngas with substantially complete carbon capture. Top gas from the DRI furnace may be used in a combustor as a fuel to form a heated exhaust stream that is used to provide reaction heating to the first processing unit, and the exhaust stream received from the first processing unit may be further processed so that at least a portion of the exhaust stream may be recycled to the combustor.

### CROSS-REFERENCE TO RELATED APPLICATIONS

The present application claims priority to U.S. Provisional Patent Application No. 63/567,184, filed Mar. 19, 2024, the disclosure of which is incorporated herein by reference.

### FIELD OF THE DISCLOSURE

The present disclosure relates to systems and methods for producing metallic iron from iron ore by direct reduction.

### BACKGROUND

A method for producing iron from iron ore is known as direct reduced iron (“DRI”). DRI may use a synthesis gas (a mixture of hydrogen and carbon monoxide, also known as “syngas”) to produce a solid metallic iron having a sponge-like structure comprising approximately 85% by weight metallic iron. The remainder may include carbon, unreacted ore, and gangue, which encompasses other unreacted oxides originally present in the iron ore. The iron product is sometimes called “sponge iron”. DRI processes have emerged as a key for the global decarbonization of the steelmaking industry. DRI processes may reduce approximately 50% of the carbon intensity compared to blast furnace processes.

Various methods have been proposed to reduce carbon feed into or improve capture of carbon emissions from DRI processes. For example, MIDREX® DRI systems (Kobe Steel, Ltd.; Tokyo, Japan) substitute hydrogen fuel for natural gas for up to 30% of the fuel requirement without modification, and retrofitting may be done to achieve 100% replacement of natural gas with hydrogen. There are other competing commercial processes, such as COREX® (Primetals Technologies Austria GmbH; Linz, Austria), HIsmelt (Technological Resources PTY LTD; Melbourne, Australia), and FINEX® (Voest-Alpine Industrieanlangenbau GMBH, Linz, Austria), that reduce iron ore to sponge iron or liquid iron. Downstream processes for decarbonization of any of the aforementioned iron refining processes may include traditional amine-based sorbents, such as methyldiethanolamine (MDEA) solutions, other CO₂ solvents/absorbents in physical scrubbing units or pressure swing absorption (PSA) units to capture CO₂ from the iron furnace exhaust gas, sometimes referred to as “top gas”.

### SUMMARY OF THE DISCLOSURE

The present disclosure relates to systems and methods for production of iron. The iron is preferably produced in a direct reduction process such that the formed iron may be referenced as direct reduced iron (“DRI”). The DRI may be produced according to the present disclosure with substantial carbon capture, where the term “substantial” is defined as meaning about 95 molar percent (mol %) or greater, such as about 98 mol % or greater, such as about 99 mol % or greater, and such as about 99.8 mol % or greater. The term “substantial carbon capture” means that about 95 mol % or greater, such as about 98 mol % or greater, such as about 99 mol % or greater, and such as about 99.8 mol % or greater of the total amount of carbon produced in a direct reduction process is retained and then controllably produced as a product, such as a concentrated, refined, or purified gaseous or liquid CO₂. The ability to retain the produced carbon is achieved even though syngas is used as the reductant in the DRI furnace. As further described, the syngas for use in the DRI furnace may be prepared using systems and methods that achieve complete retention or substantial retention of all the utilized carbon, where the term “complete” is defined as meaning at least 99.999%, and where the term “substantial retention” is defined as meaning about 98 mol % or greater, such as about 99 mol % or greater, or such as about 99.9 mol % or greater carbon retention. Moreover, the top gas passing from the DRI furnace may be handled with complete retention or substantial retention of all carbon-containing materials present in the top gas. As also described, the top gas may be recycled to the syngas production portion of the embodiment processes such that the top gas carbon components are either combusted to complete oxidation or pass through and are retained and eventually produced as part of the synthesis gas production process.

In one or more embodiments, which may be combined with other embodiments, the present disclosure provides iron production methods as well as systems and apparatuses suitable for carrying out the methods. These systems and methods may be configured from a variety of combinations of components and process steps as described. In one or more embodiments, which may be combined with other embodiments, an oxy-fuel heated iron production method may be carried out such that a fuel, such as a DRI furnace top gas, is combusted in a combustor, such as an oxy-combustor, with an oxidant to generate a hot combustion gas comprising predominately carbon dioxide. “Predominately” is defined as meaning greater than 50%, such as 80% or greater, such as about 90% or greater, and such as about 95% or greater. The content of carbon dioxide in the hot combustion gas is given as a weight percent (“wt %”) and is based on the total composition of the hot combustion gas. This hot combustion gas may release a portion of its heat from combustion and be cooled in first processing unit, such as a CO₂ convective reformer (“CCR”).

The heat released in the first processing unit is utilized for reforming a carbonaceous feed, such as a gas comprising one or more hydrocarbons, such as natural gas, and steam into a syngas, providing a syngas stream. The syngas stream may be introduced in part or in total to the DRI furnace. In one or more embodiments, the syngas stream may be referenced as a first syngas stream and may be further processed in a second processing unit to provide a second syngas stream that is then introduced to the DRI furnace. As such, only the “first” syngas stream may be introduced to the DRI furnace, only the “second” syngas stream may be introduced to the DRI furnace, or part of the first syngas stream and at least part of the second syngas stream may be introduced to the DRI furnace. The second unit may be any unit effective to further reform any hydrocarbon remaining in the first syngas stream, such as an oxygen secondary reformer (“OSR”) or a partial oxidation (“POX”) reactor or unit.

The hot combustion gas utilized for heat in the first processing unit may then pass from the first processing unit, may be further cooled, and may be dewatered before being recycled back to the combustor as a diluent for use in forming the hot combustion gases, as previously described. At least a portion of the CO₂ recovered from what was the hot combustion gas may be passed from the system as a substantially pure CO₂ product. In one or more embodiments, which may be combined with other embodiments, at least part of the CO₂ may be mixed with oxygen, such as from an oxygen source, such as from an air separation unit (“ASU”), and be provided as the oxidant to the combustor. In one or more embodiments, which may be combined with other embodiments, oxygen may be provided to the second processing unit, such as the OSR.

In one or more embodiments, which may be combined with other embodiments, the present disclosure may provide iron production plants including any combination of components and features otherwise described herein. An iron production plant, for example, may comprise: a combustor configured to produce a heated stream of predominately carbon dioxide (CO₂); a first processing unit that is optionally a CO₂ convective reformer (CCR) and that is arranged to receive the heated stream of predominately CO₂, arranged to separately receive a hydrocarbon and one or more reformants, and configured to provide a first synthesis gas (syngas) stream comprising syngas that is formed in the first processing unit; optionally, a second processing unit that is arranged to receive at least a portion of the first syngas stream, that is arranged to separately receive an oxygen containing stream, and that is configured to provide a second syngas stream comprising at least syngas that is formed in the second processing unit; and a furnace arranged to receive one or more iron oxides, arranged to separately receive a reducing gas stream comprising at least a portion of one or both of the first syngas stream and the second syngas stream, and configured to provide a heated, metallic iron product. In further embodiments, the iron production plant may be defined in relation to any one or more of the following statements, which statements may be combined in any number and order.

The reformant may comprise one or more of CO₂, carbon monoxide (CO), hydrogen gas (H₂), and steam.

The second processing unit may be an oxidative reactor.

The oxidative reactor may comprise one or more of an oxygen secondary reformer (OSR), a partial oxidation (POX) reactor, and a partial combustion unit.

The furnace further may be configured to provide a top gas.

The iron production plant further may comprise a top gas cleanup unit arranged to receive the top gas.

The combustor may be arranged to receive at least a portion of the top gas.

One or both of the first processing unit and the second processing unit may be arranged to receive at least a portion of the top gas.

The iron production plant further may comprise a heating stream processing unit arranged to receive at least a portion of the heated stream of predominately CO₂ from the first processing unit.

The combustor may be arranged to receive a stream of predominately carbon dioxide from the heating stream processing unit.

The heating stream processing unit may comprise a compressor or a pump.

The heating stream processing unit further may comprise a cooler.

The second processing unit expressly may be present or expressly may be absent.

In one or more embodiments, which may be combined with other embodiments, the present disclosure may provide processes or methods for production of iron. For example, a process for iron production may comprise: combusting a fuel with an oxidant in a combustor to form a heated stream comprising predominately carbon dioxide (CO₂); reacting a hydrocarbon with reformant in a first processing unit, which optionally is a CO₂ convective reformer (CCR) and that is that is heated by at least a portion of the stream comprising predominately CO₂ to form syngas and receiving from the first processing unit a first syngas stream; optionally introducing at least a portion of the first syngas stream to a second processing unit configured to form additional syngas and provide a second syngas stream; and introducing a reducing gas comprising at least a portion of one or both of the first syngas stream and the second syngas stream to a furnace configured to convert one or more iron oxides into metallic iron. In further embodiments, the iron production process may be defined in relation to any one or more of the following statements, which statements may be combined in any number and order

The process may comprise passing a top gas from the furnace to the combustor as at least a portion of the fuel.

The process further may comprise processing the top gas in a top gas cleanup unit to remove one or more impurities from the top gas.

One or more impurities may include solids.

The process further may comprise processing at least a portion of the stream comprising predominately CO₂ in a processing unit to modify one or more of a pressure, a temperature, and a water content of the stream comprising predominately CO₂ to provide a processed CO₂ stream.

The process further may comprise pressurizing at least a portion of the stream comprising predominately CO₂ in one or more compressors or pumps.

The processing further may comprise cooling at least a portion of the stream comprising predominately CO₂.

The may comprise cooling to less than a saturation point temperature of water in the stream comprising predominately CO₂.

The process further may comprise one or both of: recycling a portion of the processed CO₂ stream to the combustor; and receiving at least a portion of the processed CO₂ stream as a CO₂ product.

The process further may include the step of introducing at least a portion of the first syngas stream to a second processing unit configured to form additional syngas and provide a second syngas stream.

In one or more embodiments, which may be combined with other embodiments, the present disclosure may provide processes or methods for decarbonizing an existing direct reduced iron (DRI) production plant. For example, a process for decarbonizing an existing DRI production plant may comprise: operating a DRI furnace in a DRI production plant so introduced iron ore is reduced to metallic iron using introduced syngas, and a top gas is received from the DRI furnace; combusting at least a portion of the top gas with an oxidant in a combustor to form a combustion product stream comprising predominately carbon dioxide (CO₂) and optionally including water; forming the syngas from a hydrocarbon and a reformant in at least one syngas processing unit using at least a portion of the combustion product stream comprising predominately CO₂ as a heating fluid stream; and producing at least a portion of the CO₂ in the combustion product stream comprising predominately CO₂ received from the at least one syngas processing unit as an exportable CO₂ stream.

These and other features, aspects, and advantages of the disclosure will be apparent from a reading of the following detailed description together with the accompanying drawings, which are described. The disclosure includes any combination of elements, components, and features that are described, regardless of whether such elements, components, and features are expressly combined in a specific embodiment description. This disclosure is intended to be read holistically such that any separable features, components, or elements of the disclosure, in any of its various aspects and embodiments, should be viewed as intended to be combinable unless the context clearly dictates otherwise.

### BRIEF DESCRIPTION OF THE FIGURES

Having described the disclosure in the foregoing general terms, reference will now be made to the accompanying drawings, which are not necessarily drawn to scale, and which should be viewed as illustrating example embodiments of the presently disclosed subject matter.

FIG. 1 provides a flowchart illustrating an iron production system and process combining a combustor, a first processing unit configured for syngas formation, a second processing unit configured for syngas formation, and a DRI furnace, according to embodiments of the present disclosure, which may be combined with one or more additional embodiments.

FIG. 2 illustrates a combustor that may be used in an iron production system or process according to embodiments of the present disclosure, which may be combined with one or more additional embodiments.

FIG. 3 illustrates a CO₂ convective reformer that may be used as a first processing unit in an iron production system or process according to embodiments of the present disclosure, which may be combined with one or more additional embodiments.

FIG. 4A and FIG. 4B illustrate processing units that may be used for processing a warm stream comprising CO₂ in an iron production system or process according to embodiments of the present disclosure, which may be combined with one or more additional embodiments.

### DETAILED DESCRIPTION OF THE DISCLOSURE

The present subject matter is described more fully with reference to the one or more embodiments. These embodiments are described so that this disclosure will be thorough, complete, and will fully convey the scope of the subject matter to those skilled in the art. Indeed, the subject matter may be embodied in many different forms and should not be construed as limited to the embodiments set forth; rather, these embodiments are provided so that this disclosure will satisfy applicable legal requirements. As used in the specification and in the appended claims, the singular forms “a”, “an”, and “the” include plural referents unless the context clearly dictates otherwise.

The present disclosure provides for improved manners of iron production and processes, systems, and equipment that may individually or in combination exhibit the improvements in the production of iron, and particularly metallic iron. One or more embodiments of the iron production systems and processes are provided, and the one or more embodiments are described individually only for ease of disclosure and understanding. The one or more embodiments, however, are expressly intended to be useful either individually or in any combination with the one or more embodiments. It is understood that each embodiment provides improvements in iron production arising from the specific features of the individual embodiment. Individual embodiments arise from recognition of shortcomings in the existing methods and equipment used for iron production. Each individual embodiment provides a useful improvement and advantage in iron production. The improvements and advantages may be multiplied through combinations of the individual embodiments. The unique features of each embodiment are evidence that the improvements achieved with the combinations of the embodiments are not an expected, cumulative effect but rather may demonstrate synergistic effects arising from the various combinations of the individual embodiments.

Given the long investment cycles of heavy industry assets, decarbonizing existing DRI facilities is believed to be a key component for achieving net zero carbon emission goals by year 2050. The International Energy Agency (IEA) estimates that greater than 30% of existing DRI facilities will reach their investment in the next decade, meaning that there is an urgent need for new and non-obvious technologies that are configured to produce DRI with zero or near-zero carbon emission and that may significantly reduce industrial emissions globally.

In known processes that use a hydrogen feedstock, additional pre-heating and other pre-treatment of introduced hydrogen may be required depending upon the quality and quantity of the hydrogen feedstock. This increases process complexity and may require additional processing units. While syngas may be used as a reductant for certain DRI technologies, such processes are known to introduce carbon and carbon emissions into the DRI production stream, which then require downstream carbon capture processes and units, which again lead to increases operating expenses and capital expenses. By combining a DRI furnace with processing units and processing methods as presently described, however, carbon emissions may be completely or substantially eliminated without the requirement of any additional, expensive, downstream capture units. Dedicated CO₂ recovery equipment that unnecessarily increases plant size and potentially reduces run-time operability, such as pre- or post-combustion carbon capture systems, such as methyldiethanolamine scrubbing, thus may be eliminated.

The presently disclosed systems and methods are advantageous over the prior described iron processing technologies, such as conventional natural gas or blue hydrogen fed DRI. The disclosed processes and systems have substantially complete CO₂ retention and production from the syngas reforming process and the processing of the DRI top gas without necessitating a dedicated pre or post combustion carbon capture systems. The result is an inherently low carbon intensity system and process that produces DRI at scale with greater efficiency and substantially complete CO₂ retention and production as a product at a competitive cost.

In addition to new builds, the presently disclosed systems and methods are advantageous as a retrofit to an existing DRI production system. The disclosed systems are configured with implementation flexibility and, for example, may produce a syngas that is identical, substantially identical, or similar in composition to the syngas compositions that are already commonly used in existing DRI furnace systems. The embodiment systems and processes thus may be implemented with an existing DRI furnace with little or no modifications to the existing DRI furnace. As such, the presently disclosed subject matter provides a competitive option for producing low carbon DRI versus other options, such as utilizing green hydrogen, which may or may not be accessible or economically feasible.

The present systems and methods include combinations of a combustion apparatus and process, a synthesis gas production apparatus and process, and a DRI apparatus and process that provide for production of DRI while also controllably mitigating CO₂ emissions. This configuration and operation further provide advantages in efficiency compared to blue hydrogen by directly converting natural gas into syngas while expressly including CO₂ retention and production. This may be achieved, in one or more embodiments, through flexible and seamless integration of the presently disclosed systems and methods into an existing DRI furnace system without the requirement of any modifications or without significant modifications to the existing furnace while still enhancing CO₂ retention towards 100%. The presently disclosed systems and methods may provide DRI capacity on par with current state of the art DRI processes, for example, in the range of 2 million metric tons DRI produced yearly. It is reported that current DRI processes emit on average about 0.5 to about 0.8 metric tons of CO₂ per metric ton of DRI produced, whereas the disclosed systems and methods may produce less than 0.008 metric tons of CO₂ per metric ton of produced DRI because of the ability to controllably produce the carbon dioxide and not reject it to the atmosphere. Simultaneously, approximately 1 million metric tons of CO₂ yearly may be produced as a product.

The present disclosure provides for production of DRI utilizing combinations of apparatuses and processes that enable use of syngas as a reductant in a DRI furnace while decarbonizing each aspect of the apparatuses and processes. A combustion apparatus and process, a synthesis gas production apparatus and process, and a DRI apparatus and process may be combined so that all or substantially all of any carbon emissions, such as CO₂, are eliminated or are retained and optionally produced as a product, such as for sequestration or other industrial uses. Decarbonization of DRI production may be provided in relation to one or a combination of embodiments of the present disclosure. In one or more embodiments, which may be combined with other embodiments, decarbonization may be achieved at least in part by forming the syngas for use in the DRI furnace using a process or using a system whereby the syngas has substantially no CO₂ content or has a low CO₂ content, such as about 10 mol % or less or such as about 5 mol % or less CO₂ content. In one or more embodiments, which may be combined with other embodiments, decarbonization may be achieved at least in part by processing the carbon-containing top gas from the DRI furnace in a combustor configured to provide a heated stream of predominately CO₂. In one or more embodiments, which may be combined with other embodiments, decarbonization may be achieved at least in part by using the heated stream of predominately CO₂ as a heating stream in the syngas production process. In one or more embodiments, which may be combined with other embodiments, decarbonization may be achieved at least in part by recycling at least part of the heated stream of predominately CO₂ back to the combustor. In one or more embodiments, which may be combined with other embodiments, decarbonization may be achieved at least in part by providing a stream of substantially pure CO₂ from a synthesis gas production unit as a product stream.

In one or more embodiments, which may be combined with other embodiments, DRI production may be carried out so that a DRI furnace is operated using known parameters, and decarbonization may still be achieved considering the combination with the specific synthesis gas production unit and production method and with the oxy-fuel combustor that may process top gas from the DRI furnace. A syngas may be produced using a first processing unit, such as a CCR, combined with a second processing unit, such as an OSR, to convert a gaseous fuel, for example, a natural gas, into syngas that is used as the reducing agent in the DRI furnace. The first processing unit advantageously may utilize heated CO₂ as the heating fluid for the reforming process to produce a first syngas stream. The first syngas stream may then be further converted in the second processing unit to produce a second syngas stream. The second syngas stream may then be fed into the DRI furnace. Alternatively, the first syngas stream may be directed in part or in total into the DRI furnace without processing in the second processing unit. Alternatively, a portion of the first syngas stream, such as about 1 mol % to about 99 mol %, may be introduced to the DRI furnace, and a portion of the first syngas stream, such as about 99 mol % to about 1 mol %, may be introduced to the second processing unit as noted previously. The heated CO₂ passing from the first processing unit may be further processed, such as condensing and removing water therefrom, to provide a substantially pure stream of CO₂ that may be utilized for geological sequestration or other industrial uses. A “substantially pure” CO₂ stream will comprise about 95 mol % or greater, such as about 98 mol % or greater, such as about 99 mol % or greater, such as about 99.5 mol % or greater, or such as about 99.9 mol % or greater CO₂. The production of syngas for use as a reducing gas in the DRI furnace is at least substantially decarbonized in this manner. Likewise, decarbonization in one or more embodiments of the present systems and processes may be further achieved in relation to the top gas from the DRI furnace. Such top gas may further comprise a significant concentration of carbon-containing components, such as carbon monoxide (CO), CO₂, and particulate solids. The top gas stream may be introduced to the combustor to produce the heated CO₂ stream, which is then directed to the first processing unit. The combustor may completely or substantially completely oxidize a variety of impurities and fuel components that may be present in the top gas stream. In one or more embodiments, which may be combined with other embodiments, a top gas cleanup unit or system may be used to remove solids, such as carbonaceous solids, and other non-gaseous impurities, or to remove other gaseous system impurities along with carry-over solids, prior to introduction into to the combustor.

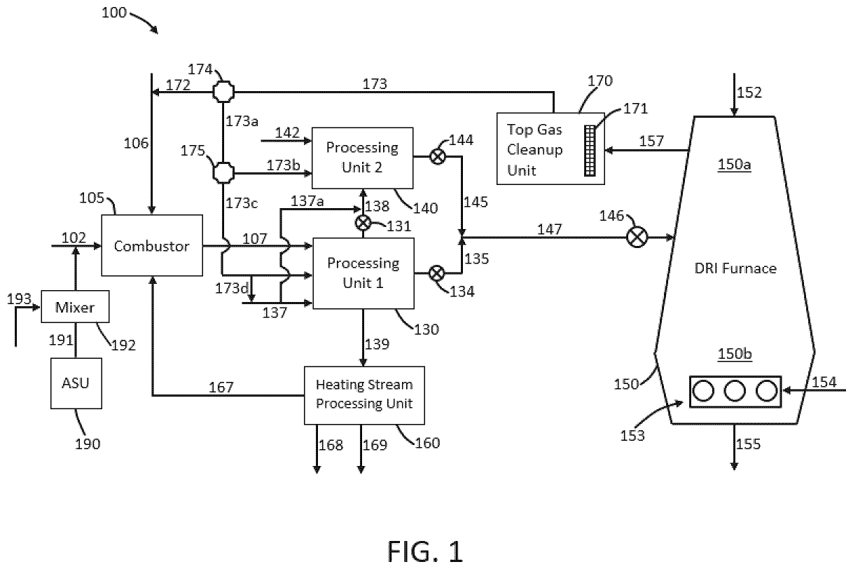

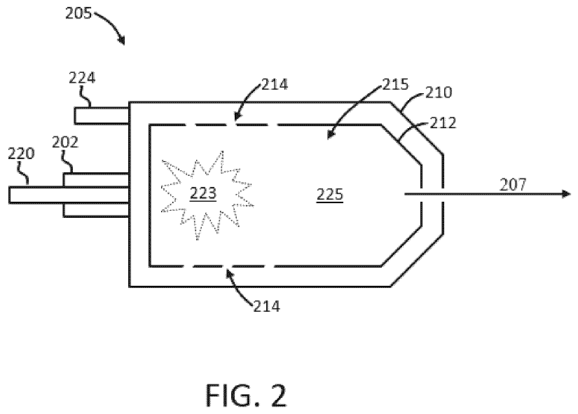

With reference now to FIG. 1, an iron production plant 100, which may be referenced as a DRI plant or DRI system, includes a combustor 105 that produces a heated stream of predominately carbon dioxide through line 107. The combustor 105 may be an oxy-fuel combustor and may have any configuration recognized as useful in an oxy-fuel combustion process. For example, as illustrated in FIG. 2, a combustor 205 may be arranged to define an outer combustor shell 210 and a combustor liner 212 that defines internally a combustion chamber 215. The combustor may include at least one fuel inlet 220 configured to receive a fuel, at least one oxidant inlet 202 configured to receive an oxidant, and at least one diluent inlet 224 configured to receive a diluent, such as a recycled CO₂ stream. Separate inlets for each component need not necessarily be present, and mixtures of any one or more of the fuel, oxidant, and diluent may be input through a single inlet. The oxidant inlet 202 may be arranged substantially coaxially with the fuel inlet 220 or may be off set. Diluent may pass through one or more openings 214, which are defined by the configuration of the combustor liner 212, to be input substantially directly into the combustion chamber 215. Additionally, diluent may also flow between the liner 212 and the combustor shell 210. In one or more embodiments, which may be combined with other embodiments, the diluent may be mixed with substantially pure oxygen to form the oxidant, In one or more embodiments, the oxygen content of the oxidant is in a range of from about 10 mol % to about 60 mol %, such as from about 12 mol % to about 50 mol %, or such as from about 15 mol % to about 40 mol %. Referring to FIG. 1, substantially pure oxygen passing to the combustor 105 through oxidant line 102 may be received from an oxygen source, such as a pipeline or an air separation unit (ASU) 190. In some instances, line 102 may originate directly from the ASU 190, or as shown in FIG. 1, a separate line 191 may be used for passage of the formed oxygen to the oxidant line 102. Diluent may be input to the combustor in addition to the diluent that is mixed with the oxygen to form the oxidant. Diluent in line 193 may be mixed with the oxygen in line 191, for example, via input directly into line 191 or into a mixer 192. In some instances, the diluent likewise may be mixed with the fuel. Referring to FIG. 2, the fuel and oxidant may be injected specifically into the combustion chamber 212. Oxidant may also be injected through at least a portion of the liner 212, such as through openings 214. Oxidant alone, diluent alone, or both oxidant and diluent may be input to the combustor chamber 215 through any one or more of openings 214. The combustor 205 may be arranged to receive a first part of the diluent into a reaction zone 223 of the combustion chamber 212 and to receive a second part of the diluent into a dilution zone 225 of the combustion chamber 212, which is downstream of reaction zone 223. Combustor exhaust passes from the combustor 205 through line 207 and comprises predominately CO₂, predominately having the meaning previously stated. The combustor exhaust may otherwise comprise about 60 mol % or greater, such as about 70 mol % or greater, or such as about 80 mol % or greater CO₂. In some instances, the combustor exhaust may also comprise water or impurities.

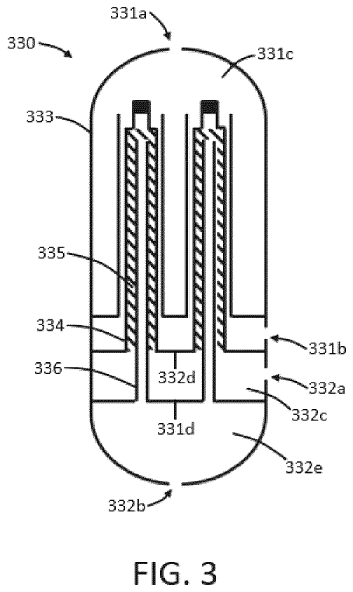

Referring to FIG. 1, a first processing unit 130 is used for forming a synthesis gas. The first processing unit may particularly be a CO₂ convective reformer. In one or more embodiments, which may be combined with other embodiments, a CCR useful as the first processing unit 130 may have an arrangement as illustrated in FIG. 3. With reference to FIG. 3, the CCR 330 may be configured with several fluid ingress and egress ports, such as a heating fluid inlet 331a, a heating fluid outlet 331b, a reactant inlet 332a, and a reaction product outlet 332b. Any of the inlets may be referenced for ease of discussion as being a first inlet, a second inlet, and so on. Likewise, any of the outlets may be referenced as a first outlet, a second outlet, and so on. The heating fluid enters a containment vessel 333 through the heating fluid inlet 331a and passes around the reaction tube sets defined by the outer catalyst tube 334 and the inner reaction product tube 336 to provide heat for the reformation process through the walls of the outer catalyst tube 334. This heating is predominately convective; however, in one or more embodiments, which may be combined with other embodiments, a minor portion of the heating may be via other heating modes, such as radiative heating. Hydrocarbon and steam enter the containment vessel 333 through the reactant inlet 332a. The reactant inlet 332a provides fluid access to a reactant space 332c that is separated from a heating fluid space 331c by a reactant tube sheet 332d, which prevents mixing of the reactants with the heating fluid. As reactants pass through the catalyst material 335, syngas product forms and passes through the inner passage of the inner reaction product tube 336 into a reaction product space 332e, which is separated from the reactant space 332c by a product tube sheet 331d. The formed syngas passes from the pressure vessel 333 through the reaction product outlet 332b. As illustrated in FIG. 3, the reactants flow upward through the catalyst while the heating fluid flows down around the so-called “scabbard tubes” (outer catalyst tube 334) and the formed syngas flows down through the so-called “bayonet tubes” (inner reaction product tube 336) in the void defined by the interior surface of the inner reaction product tube 336. The directional arrangement of parts as illustrated in FIG. 3 is not intended to be limiting. The parts of the CCR may be arranged as desired and lead to modifications of directional fluid flows, such as through the CCR 330. For example, the parts in FIG. 3 may be arranged so that the reactants flow downward through the catalyst while the heating fluid flows upward around the tubes, and the formed syngas flows upward through the inner reaction product tube.

In one or more embodiments, which may be combined with other embodiments, the catalyst used may comprise one or both of a nickel-based catalyst or a cobalt-based catalyst. The catalyst may be unsupported or may be present on a support material, such as a zeolite, alumina, aluminate, or other suitable catalyst support.

The CCR 330 may be configured so that reactants are received to the tube side of the CCR 330 while the heated stream of predominately carbon dioxide in line 107 is received in the shell side of the CCR 330. The countercurrent flow of the heated stream of predominately carbon dioxide provides reaction heating to the endothermic syngas formation reaction.

Reactants used in the CCR 330, for example, one or more hydrocarbons, such as a natural gas, and a reformant, such as CO₂, steam, or mixtures thereof, may be received by the CCR 330 through line 137 (see FIG. 1), such as at inlet 332a. The reactants may be premixed and received to the CCR 330 through a single inlet or may be received through separate inlets. In one or more embodiments, which may be combined with other embodiments, the hydrocarbon and one or more reformants may be mixed before introduction to form a so-called “mixed feed”, which is then introduced to the catalyst side of the CCR 330, such as being introduced through line 137. As discussed in greater detail following with reference to FIG. 1, reformant may be introduced separately to the first processing unit 130 through line 173c and optionally may be introduced to the second processing unit 140 through line 173b if the second processing unit is present. Reformant from line 173c may be introduced via line 173d into line 137 to from a mixed reactant stream in line 137 comprising reformant and hydrocarbon. The reformant may comprise any one or more of CO₂, CO, H₂, and steam. The mixed feed may be further preheated prior to introduction into the first processing unit 130. Syngas formed in the first processing unit 130, such as the CCR 330, may pass from the first processing unit via one or both of line 135 and line 138, such as through reaction product outlet 332b in CCR 330. The syngas in one or both of line 135 and line 138 may be referenced as a first syngas. The combustor exhaust comprising predominately CO₂, having been partially cooled by transferring heat through the CCR and into the reforming reaction(s), may pass from the CCR 130, 330 through heating fluid outlet 331b utilizing line 139 (see FIG. 1).

A second processing unit optionally may be present and may be arranged to receive at least a portion of the first syngas from the first processing unit. In one or more embodiments, which may be combined with other embodiments, the second processing unit may be an oxidative reformer that uses oxygen and a reactant in the reforming reactions. As shown in FIG. 1, the second processing unit, and particularly an oxidative reformer, may be an oxygen secondary reformer 140, which may be substantially similar to an autothermal reformer (“ATR”). Although the following description may specifically reference an OSR, one may recognize that different reactors may be utilized as the second processing unit or oxidative reactor. Reference to an OSR may be used for ease of description and is not intended to limit the scope of the second processing unit unless otherwise specifically stated.

A second processing unit configured as an OSR may be configured to operate adiabatically in that a fuel-rich stream, such as the first syngas stream, is reacted with an oxidant, such as substantially pure oxygen, which may be provided to the second processing unit 140 in FIG. 1 through line 142. The amount of oxidant relative to the composition of the fuel is preferably sub-stoichiometric such that the molar ratio of oxidant to fuel is less than about 1.0. Operating under these conditions, only a relatively small portion of the fuel introduced may be consumed whereas the temperature of the reformate may rise such that a greater content of the remaining hydrocarbons in the first syngas stream are converted to syngas components in the second processing unit.

In one or more embodiments, an OSR utilized as a second processing unit may include a catalyst. Likewise, other types of reactors utilized as a second processing unit according to the disclosure may include a catalyst. A catalyst for use in the second processing unit, including when configured as an OSR specifically, may be a nickel-based catalyst or other catalyst useful in oxygen reforming or autothermal reforming. The catalyst may be unsupported or may be present on a support material, such as a zeolite or alumina. In other embodiments, the OSR or other second processing unit may be expressly free of catalyst material. A catalyst-free second processing unit, such as a partial oxidation reactor, may be useful for enabling increased operating pressures and temperatures and for producing synthesis gas with a greater CO content relative to the hydrogen content and relative to any carbon dioxide that may be present versus if a catalyst was present.

Any second process unit suitable for operating as discussed herein may be utilized in the present systems and methods. For example, an OSR may be configured with a burner situated at the top of, and within, a refractory-lined vessel. Oxidant and fuel mix in the OSR, and the oxidant is fully consumed into a high temperature, combusted gas. If a catalytic OSR is utilized, the high temperature, combusted gas will leave a top, combustion zone and enter a bottom, catalytic zone where the gas composition is modified in the presence of a reforming catalyst that is specially formulated to withstand the extremely high temperatures. The second processing unit 140 may include at least one inlet arranged to receive at least a portion of the first syngas stream, and such inlet may correspond to the position where line 138 meets the second processing unit 140 in FIG. 1. The second processing unit 140 may include at least one inlet arranged to receive an oxygen-containing stream, and such inlet may correspond to the position where line 143 meets the second processing unit 140 in FIG. 1.

Some or all of the synthesis gas introduced in the first syngas stream through line 138 may be reformed within the second processing unit 140 to form a second synthesis gas in terms of having a different ratio of hydrogen, carbon monoxide, methane, reformants, and other constituents relative to the introduced first syngas stream. It is possible, however, that some content of the first syngas stream components may pass through the second processing unit 140 unreacted or unreformed. Regardless, it is expected that a second syngas exiting the second processing unit 140 through line 145 will have a different composition than the first syngas stream exiting the first processing unit 130, 330 through line 138 (and line 135 where a portion of the first syngas stream is also passed to the DRI furnace 150). The second processing unit 140 includes at least one outlet for passing the second syngas stream, such as where line 145 couples with the second processing unit 140 in FIG. 1.

In one or more embodiments, which may be combined with other embodiments, the second processing unit receiving the first syngas through line 138 may comprise an oxidative reactor, which may comprise one or more of an OSR, a POX reactor, and a partial combustion unit. A POX reactor utilized according to the present disclosure may include any reactor that is known to be useful in the formation of partially combusted gases. For example, known types of gasifiers may be used and operated under conditions effective so that the oxidizable components of the introduced first syngas are only partially oxidized. Likewise, fluidized bed reactors may be used. Further, the reactor may be a catalyzed reactor or may be a non-catalyzed reactor. The POX reactor may be operated under conditions where substantially only hydrocarbon remaining in the first synthesis gas is oxidized, and preferably where substantially all of any remaining hydrocarbons are oxidized selectively relative to any further oxidizable materials in the first synthesis gas.

A “partial combustion unit,” as recognized by one of skill in the steel production art, may include a specific component within a Direct Reduction Plant (“DRP”) where a controlled, incomplete combustion process occurs. The incomplete combustion process generates a reducing gas mixture comprising carbon monoxide and hydrogen, and this reducing gas mixture may be used to chemically reduce iron ore into metallic iron before further processing into steel. The partial combustion unit is effective to partially combust a fuel to create a specific gas composition for the reduction process. A POX reactor may be a specific type of partial combustion unit where syngas reaches substantial chemical equilibrium by utilizing greater residence times, such as residence times of greater than 1 second, compared to other types of partial combustion units where residence times may be less than 1 second. POX reactors, because of the greater residence times, may benefit from configurations that utilize a refractory lined vessel designed with recirculating flow patterns, whereas a non-POX partial combustion unit may comprise, consist essentially or, or consist of a burner positioned within a refractory-lined transfer line. Partial combustion units, including POX reactors specifically, may use sub-stoichiometric amounts of oxygen relative to the fuel components. The sub-stoichiometric amounts being useful to maximize the concentration of H₂ and CO in the resulting reactor exhaust. This may be beneficial since H₂ and CO are the components that participate in the reduction of iron oxides, while the fully oxidized combustion products, such as H₂O and CO₂, are ineffective for reducing iron oxides to form metallic iron.

Optionally, a steam stream may be introduced to the secondary processing reactor. For example, in embodiments where the second processing unit 140 is a POX reactor, line 142 may be configured for introduction of steam into the POX reactor. Useful POX reactors may include internal heat transfer sections absorbing radiant heat from the POX burner. The internal heat transfer sections may be configured for conductive, convective, or both types of heating. As already noted, any of the aforementioned alternatives may be used in place of the OSR as the second processing unit (element 140 in FIG. 1).

In one or more embodiments, which may be combined with other embodiments, the second processing unit 140 may be optional. As such, the present systems and processes may be implemented using only the first processing unit 130 in the express absence of the second processing unit 140. Alternatively, the second processing unit 140 may be present but may be optionally operable. The first processing unit 130 may include an outlet for passage of the first syngas stream through line 135, which line may include a valve 134. The valve 134 may be operable so that all or part or none of the first syngas stream passes from the first processing unit 130 through line 135. Similarly, line 138 discussed previously may include a valve 131, and the valve 131 may be operable so that all or part or none of the first syngas stream passes from the first processing unit 130 through line 138. Further, line 145 discussed previously may include a valve 144, and the valve 144 may be operable so that all or part or none of the second syngas stream passes from the second processing unit 140 through line 145. The iron production plant 100 thus may be configured in one or more embodiments so that the second processing unit 140 is either absent or is closed from the flow path extending between the first processing unit 130 and the DRI furnace 150. In such embodiments, the valve 134 is open, and the valves 131 and 144 are closed if the second processing unit 140 is present but excluded from the operable flow path. The first syngas stream passes from the first processing unit 130 through line 135 with open valve 134 and then passes to line 147 for introduction to the DRI furnace 150 as the reducing gas. Valve 146 may be present in line 147 to control flow rate of the reducing gas stream into the DRI furnace 150. The iron production plant 100 alternatively may be configured in one or more embodiments so that the second processing unit is present and operable such that all of the first syngas stream received from the first processing unit 140 passes through line 138 and open valve 131 to be introduced to the second processing unit 140. The second syngas stream is received from the second processing unit 140 through line 145 and open valve 144 and then passes to line 147 for introduction to the DRI furnace 150 as the reducing gas. Further, alternatively, the iron production plant 100 may be configured so that reducing gas is received in line 147 from both of the first processing unit 130 and the second processing unit 140. In such embodiments, a first portion of the first syngas stream may pass through line 138 to the second processing unit 140, a second portion of the first syngas stream may pass through line 135 to line 147, and the second syngas stream may pass through line 145 to line 147. The streams in lines 135 and 145 thus combine in line 147 to form the reducing gas stream that passes to the DRI furnace 150. Valves 131, 134, and 144 may be controllable so that mass or volume flow through lines 138, 135, and 145, respectively may be varied, and the composition of the reducing gas stream in line 147 thus may be controlled accordingly.

A DRI furnace 150 used in one or more embodiment systems may include at least one inlet arranged to receive the raw iron material, at least one inlet arranged to receive at least a portion of the second syngas stream, and at least one outlet for a heated, metallic iron product. The stream of a reducing gas may be introduced into the DRI furnace 150 through line 147. The DRI furnace 150 may also be configured to receive a raw iron material through line 152. The raw iron may be any material comprising ferric oxide (Fe₂O₃). The hot DRI that is in the form of reduced iron that passes from the DRI furnace 150 may do so through line 155.

Any furnace construction suitable for use in a gas-based DRI process may be utilized, such as a countercurrent shaft furnace or reactor. The shaft furnace may be configured such that, for example, iron ore pellets may be fed into an upper section 150a or top of the DRI furnace 150 where they may be preheated by the rising, hot gas comprising in part the reducing gas received through line 147 and in other part a depleted reducing gas spent from its reaction with the raw iron material. In a lower section 150b or bottom of the DRI furnace 150, one or more burners 153 may be operated to generate hot gases and provide additional heat. Burners 153, if present, may be configured to receive a fuel gas for combustion, such as through line 154. Although for the sake of clarity, certain couplings and flow lines are not provided for in FIG. 1. In one or more embodiments, which may be combined with other embodiments, a portion of the syngas produced in one or both of the first processing unit 130 and the second processing unit 140 may be introduced into the DRI furnace 150 as fuel for the burners 153. Alternatively, or additionally, a different or supplemental fuel may be used. For example, a portion of the hydrocarbon, such as a natural gas, introduced into the first processing unit 130 through line 137 may be introduced to the DRI furnace 150 through line 154 to be used as the fuel for the burners 153.

The DRI furnace 150 is operated at a temperature that will be recognized by one of skill in the art as being useful for the conversion of iron oxide to DRI. In one or more embodiments, which may be combined with the other embodiments, the DRI furnace 150 may be operated at a temperature in a range of from about 800° C. to about 1100° C. The operating temperature may, however, be in the range of operation of any of the known DRI furnaces, which typically operate over a range of temperatures where the temperature is at its greatest near the bottom of the furnace and decreases moving toward the top of the furnace. The DRI furnace 150 may be configured for reacting iron oxide (present in the iron ore introduced to the DRI furnace) with carbon monoxide and hydrogen to form metallic iron and provide a top gas, which may comprise one or both of carbon dioxide and water. The top gas may pass from the DRI furnace 150 through line 157. By the time the iron ore pellets migrate from the injection site proximate the upper section 150a and reach the lower section 150b of the DRI furnace 150, the iron oxides present in the iron ore pellets may be substantially reduced. More particularly, the iron oxides in the iron ore pellets, such as Fe₂O₃, may be reduced so that about 80 wt % or greater, such as about 85 wt % or greater, such as about 90 wt % or greater, or such as about 95 wt % or greater of the iron oxides in the iron ore pellets are converted to metallic iron (Fe) in the form of DRI. The reduced pellets reaching the lower section of the furnace may comprise about 80 wt % or greater, such as about 85 wt % or greater, or such as about 90 wt % or greater metallic iron. The rest of the reduced pellets comprise unreacted iron ore, incompletely reduced iron ore, and gangue, which includes other oxides found in iron ore.

The DRI furnace 150 further includes at least one outlet for the top gas to pass through line 157. The top gas may include a variety of components including, but not limited to, unused synthesis gas, CO₂, water vapor, and solids. In one or more embodiments, which may be combined with other embodiments, an iron production plant 100 according to the present disclosure further may comprise a top gas cleanup unit 170 configured to receive the top gas from the DRI furnace. The top gas cleanup unit 170 may include any number of features useful for removal of one or more components of the top gas. In one or more embodiments, which may be combined with other embodiments, the top gas cleanup unit 170 may comprise one or more solids filters 171. The solids filters 171 may be particularly configured for removal of solids that may be present in the top gas from the DRI furnace 150. The top gas cleanup unit 170 may be configured to remove any one or more of the components known to be present in the top gas. In one or more embodiments, which may be combined with other embodiments, and not shown in FIG. 1, the top gas cleanup unit may be expressly absent. In one or more embodiment, which may be combined with other embodiments, and as not shown in FIG. 1, top gas cleanup unit may be configured simply as a solids filter, such as solids filter 171. A circulating fluid scrubber, such as using water as the circulating fluid, may be useful to provide a combination of cooling and solid particulate removal. It is understood that the iron production plant 100 may include any further components that may be useful, such as piping, valves, control units for automated control of any processing conditions, temperature sensors, pressure sensors, and flow sensors useful for operation of the iron production plant or system.

In one or more embodiments, which may be combined with other embodiments, the iron production plant 100 may comprise one or more lines configured for passage of top gas from the top gas cleanup unit 170 (or directly from the DRI furnace 150) to one or more further components of the plant. As illustrated in FIG. 1, line 173 is configured for passage of at least a portion of the top gas from the top gas cleanup unit 170 to the combustor 105. The combustor 105 may be configured to have at least one inlet arranged to receive at least a portion of the top gas. In one or more embodiments, which may be combined with other embodiments, the inlet for receiving the top gas may be the same as the inlet for receiving fuel into the combustor. In FIG. 1, line 173 passes through splitter 174, and any portion of the gas in line 173 that does not pass to line 173a proceeds to combine with the contents within line 106. Line 106 is configured for passage of fuel to the combustor 105. In one or more of the embodiment, which may be combined with other embodiments, the top gas may comprise a portion of the fuel introduced into the combustor, such as the top gas comprising in a range of from about 5 mol % to about 95% of the fuel used in the combustor 150. In this manner, all the atomic carbon (contained as CO or CO₂) passing from the DRI furnace 150 as the top gas is routed through the combustor 150. As previously described, eventually, the gas produced by the combustor is retained and produced from the iron production plant 100 as a product or is recycled back into the process.

In FIG. 1, the iron production plant 100 may include splitter 174 and splitter 175 for allocation of the top gas in line 173 to a plurality of different components of the iron production plant. The splitters may include internal valving as useful to allow or disallow flow through the splitters to one or more outlets of the splitters. Splitter 174 may divide the top gas in line 173 so that a first portion is introduced via line 172 to line 106 and a second portion is provided through line 173a. The top gas may be partitioned through splitter 174 in suitable amounts so that the first portion and the second portion each independently may comprise any amount in a range of from 0 mol % to 100 mol %, such as about 5 mol % to about 95 mol % of the top gas in line 173.

In one or more embodiments, which may be combined with other embodiments, the portion of top gas that is introduced via line 172 to line 106 for introduction to the combustor may be in a range of from about 10 mol % to about 90 mol %, such as from about 20 mol % to about 70 mol %, or such as from about 30 mol % to about 50 mol %, of the total amount of the top gas, with the remaining top gas forming the second portion provided through line 173a. In one or more embodiments, which may be combined with other embodiments, the top gas in line 173 may be partitioned in splitter 174 so that about 10 mol % or greater, such as about 25 mol % or greater, such as about 50 mol % or greater, or such as about 60 mol % or greater is passed to line 173a. Any portion of the top gas passing through line 173a may be introduced into one or both of the first processing unit 130 and the second processing unit 140. In particular, splitter 175 may be arranged to partition the stream in line 173a into a first part that passes in line 173b to the second processing unit 140 and a second part that passes in line 173c into the first processing unit 130. The top gas may be partitioned through splitter 175 in suitable amounts so that the first part and the second part each independently may comprise any amount from 0 mol % to 100 mol % of the top gas in line 173a. In one or more embodiments, which may be combined with other embodiments, the stream in line 173a is partitioned in splitter 175 so that about 50 mol % or greater, such as about 65 mol % or greater, such as about 80 mol % or greater, or such as about 90 mol % or greater of the stream in line 173a is passed to line 173c. Passage of top gas through line 173b may be optional and thus may be excluded. As mentioned previously, the top gas in stream 173c may be introduced independently to the first processing unit 130 through line 173c. Optionally, part of the top gas in line 173c may be diverted through line 173d for mixture with the hydrocarbon in line 137 for introduction to the first processing unit 130 as a mixed gas stream. Alternatively, all of the top gas in line 173c may be combined with the hydrocarbon in line 137 for introduction to the first processing unit 130 as a mixed gas stream. Line 173c may directly merge with or otherwise combined with line 137, or the entirety of the top gas in line 173c may be introduced to line 137 via line 173d. Likewise, the hydrocarbon in line 137 may be introduced to line 173c to form the mixed gas stream for introduction to the first processing unit 130.

In one or more embodiments, which may be combined with other embodiments, the iron production plant 100 further may comprise heating stream processing unit 160, which may be configured for processing the heating fluid stream passing from the first processing unit 130 through line 139. The heating fluid stream in line 139 comprises predominately CO₂, as described foregoing. The heating stream processing unit 160 may comprise one or more steam generators or boilers, one or more preheaters, one or more coolers, one or more compressors, or one or more pumps, each of the foregoing being present individually or in any number and combination. The heating stream processing unit 160 may be configured to provide a recycle steam that is introduced to the combustor 105 through line 167. The heating stream processing unit 160 may be configured to provide a CO₂ product stream through line 168. The heating stream processing unit 160 may be configured to provide a stream of water through line 169.

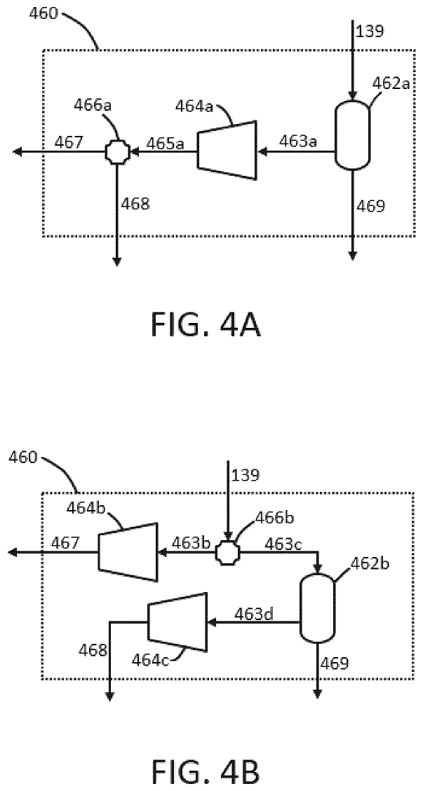

With reference to FIG. 1, FIG. 4A, and FIG. 4B, the heating stream processing unit 460 may be configured to receive the stream in line 139 and process the stream, such as for recycle to the combustor 105 or for provision of a carbon dioxide product, among other operations. In one or more embodiments, which may be combined with other embodiments, it may be desirable to compress the stream of predominately CO₂ from a first, lesser or reduced pressure to a second, greater or elevated pressure. The second, greater or elevated pressure may correspond to an operating pressure of a combustor, a pipeline, or another unit or operation configured to receive the CO₂ product. The difference between the first, lesser or reduced pressure and the second, greater or elevated pressure may be in a range of about 0.5 bar to about 150 bar, such as about 1 bar to about 100 bar. The heating stream processing unit 460 may comprise one or more compressors or pumps 464 configured for pressurizing the stream of predominately CO₂ to the second, greater or elevated pressure range.

In one or more embodiments, which may be combined with other embodiments, the stream in line 139 introduced to the heating stream processing unit 160, 460 may be split into a plurality of separate streams. Likewise, or one or more streams formed within the heating stream processing unit 460 may be split into a plurality of separate streams. In each case, partitioning of streams may be carried out before cooling, after cooling, before pressurization, or after pressurization. In the embodiments where the stream is apportioned between two or more streams, each stream may be pressurized to a pressure that is the same or is different than the remainder of the streams.

In one or more embodiments, which may be combined with other embodiments, it may be desirable to cool the stream of predominately CO₂ from a first, higher temperature to a second, lower temperature. The second, lower temperature may be approximately a water saturation point temperature of the stream of predominately CO₂. The second, lower temperature may be a temperature that is less than the water saturation point temperature but is also greater than ambient temperature. The difference between the first, higher temperature and the second, lower temperature may be in a range of about 10° C. to about 140° C., such as about 20° C. to about 100° C. The heating stream processing unit 460 may comprise one or more coolers 462 configured for cooling the stream of predominately CO₂ to the second, lower temperature range. The cooler 462 may include any component effective to one or both cool or dewater the stream received, the cooler may include components, such as air coolers, cooling water coolers, water separation units, and direct contact condensers (DCC).

In one or more embodiments, which may be combined with other embodiments, the stream in line 139 introduced to the heating stream processing unit 160, 460, or one or more streams formed within the heating stream processing unit 460, may be split into a plurality of separate streams, and such dividing of the stream may be carried out before cooling, after cooling, before pressurization, or after pressurization. In embodiments where the stream is split, the split streams may be pressurized independent from one another. Water present in the stream provided through line 139 is preferably removed to prevent damage to compressors, blowers, or pumps used to drive the CO₂ through the system. A portion of the CO₂ and water present in the stream in line 139 may be removed from the system to preserve require mass balance of the system. As illustrated in FIG. 4A, the stream 139 may be introduced to a cooler 462a, which may be configured for dewatering the introduced stream. The cooled, dewatered gas stream is provided in line 463a, and the removed water is provided through line 469. Dewatering before pressurizing may be desired to prevent damage to compression equipment due to the presence of liquid water in the stream being pressurized. The cooled, dewatered gas in line 463a is introduced to a compressor 464a to form a compressed stream in line 465a. The compressed stream in line 465a may be apportioned, such as with a splitter 466a, so that a first portion of the compressed stream of predominately CO₂ is passed through line 467 for introduction to the combustor. The second portion of the compressed stream of CO₂ passes through line 468 and from the iron product plant 100 as the CO₂ product. The CO₂ product may be optionally subject to further purification, such as oxygen removal (“deoxygenation”), desiccation, and further pressurization prior to being exported from the plant 100 as the CO₂ product. The stream in lines 468, 465a, and 467 may be substantially pure CO₂.

As illustrated n FIG. 4B, the stream of predominately CO₂ in line 139 may be divided into separate portions, such as with splitter 466b, and separately processed. A first portion of the stream of predominately CO₂ passes through line 463b, is directly introduced into the compressor 464b to form a compressed stream of predominately CO₂, and passes through line 467 for recycle to the combustor. A second portion of the stream of predominately CO₂ passes from the splitter 466b in line 463c. The line 463c introduces the contents into cooler 462b, produces both a cooled stream in line 463d and a stream of removed water through line 469. The stream of CO₂ in line 463d may be subject to further processing, such as deoxygenation, desiccation, or being pressurized in compressor 464c, providing compressed stream of CO₂ in line 468. All or part of the stream of CO₂ that is passed through line 468 may pass from the iron product plant 100 as a CO₂ product, which may be substantially pure CO₂. The heating stream processing unit 460 may be configured to provide any one or more streams of predominately CO₂ that is recycled to the combustor, a stream of predominately CO₂ that is provided as a product, which product stream may be divided into a plurality of predominately CO₂ product streams, and water.

In further aspects, the present disclosure provides processes for iron production. Such processes may be carried out using the system and parts previously described, which system and parts may be operated under specified conditions to produce syngas that may be used in a DRI furnace for iron production, to process the top gas from the DRI furnace in a combustor, and a combustor that may provide heat through a heated stream of predominately CO₂ to syngas production unit(s), such as the first processing unit. The process thus may achieve iron production with substantially none or no carbon emissions, that is substantially all or all of the CO₂ formed from carbon-containing materials introduced into the process is retained instead of being emitted and may be produced as a product.

In one or more embodiments, which may be combined with other embodiments, an iron production process may comprise a variety of steps. Although the following steps are provided in a defined order, the order is provided primarily for ease of description of the process and should not be viewed as necessarily requiring initiation of a certain step prior to initiation of a further step. Rather, one may understand that once the process is operational, all steps may be carried out substantially simultaneously, in combination, or in any order unless expressly provided otherwise.

The process may include combusting a fuel with oxygen in a combustor to form a heated stream exiting the combustor comprising predominately CO₂, which may be provided at a temperature in a range of from about 750° C. to about 1250° C., such as from about 800° C. to about 1200° C., such as from about 850° C. to about 1100° C., or such as about 950° C. This heated stream may be predominately CO₂; however, a significantly greater concentration of CO₂ may be provided. Specifically, in one or more embodiments, which may be combined with other embodiments, the heated stream exiting the combustor may have a carbon dioxide concentration in a range of from about 85 mol % to about 99.9 mol %, such as from about 88 mol % to about 99.5 mol %, or such as from about 90 mol % to about 99 mol % CO₂. The remaining fraction of the heated stream exiting the combustor may comprise water as well as lesser amounts of other impurities. The heated stream exiting the combustor may have an excess of oxygen (O₂) present, such as an oxygen concentration in a range of from about 0.1 mol % to about 5 mol %, such as from about 0.2 mol % to about 3 mol %, or such as from about 0.3 mol % to about 2 mol % 0₂.

The heated stream exiting the combustor may have a pressure of approximately atmospheric pressure or greater. For example, the pressure of the heated stream exiting the combustor may be in a range of about 40 bar or less, such as about 30 bar or less, such as about 20 bar or less, such as about 10 bar or less, or such as from about 1 bar to about 40 bar, such as from about 1 bar to about 20 bar, or such as from about 1 bar to about 10 bar.

The fuel used in the combustor may vary; however, in one or more embodiments, which may be combined with other embodiments, the present disclosure is particularly beneficial in that substantially all or all of the fuel provided to the combustor is the top gas from the DRI furnace. Optionally, a make-up fuel comprising a combustible material, such as natural gas, may be combined with the top gas such that make up fuel may comprise up to about 75 mol %, such as up to about 65 mol %, such as up to about 50 mol %, such as up to about 35 mol %, or such as up to about 20 mol % of all the fuel used in the combustor based on the total molar content of all combustible materials present in the combination of fuels. The remaining fuel used in the combustor comprises the top gas from the DRI furnace.

The present process further may comprise reacting a hydrocarbon with a reformant, such as CO₂, steam, or mixtures thereof, in the first processing unit while the first processing unit is being heated by using at least a portion of the heated stream of predominately CO₂ from the combustor. A reformant may be a compound or mixture of compounds that reform a hydrocarbon to a syngas. Steam is commonly understood to be useful as a reformant for syngas production, but CO₂ likewise may be used as a reformant and will react with methane to form CO and H₂O. Reacting the hydrocarbon and reformant in the first processing unit is effective to form syngas for a first syngas stream. The first syngas stream may comprise hydrogen and carbon monoxide because of the reformation reactions. In one or more embodiments, which may be combined with other embodiments, the first syngas may further comprise carbon dioxide. In one or more embodiments, which may be combined with other embodiments, the first syngas may comprise one or more unconverted hydrocarbons from the hydrocarbon introduced into the first processing unit.

At least a portion of the first synthesis gas stream may be passed through a second processing unit to form additional syngas having a different composition than the first syngas. In embodiments where an OSR is used as the second processing unit, the syngas of the first syngas stream is reacted with a fresh stream of an oxidant. In one or more embodiments, which may be combined with other embodiments, the oxidant is high purity oxygen, which has a purity in a range of from about 95 mol % or greater, such as about 98 mol % or greater, such as about 99 mol % or greater, or such as about 99.5 mol % or greater molecular oxygen. A high purity oxygen feed may further increase the temperature of the reformant in the second processing unit and drive the hydrocarbon concentration to near extinction through additional conversion into syngas components. The second syngas passing from the second processing unit may have a temperature in a range of from about 900° C. to about 1200° C. or such as from about 925° C. to about 1100° C. This second syngas is prepared for utilization as a feed into the DRI furnace.

The combined use of the first processing unit and the second processing unit for forming the syngas for input to the DRI furnace may be beneficial to achieve desired syngas characteristics. By using a CCR, for example, the first processing unit may be efficiently heated using exhaust gas comprising predominately CO₂ that is received from the combustor. The use of the combustor is beneficial to receive and combust at least a portion of the top gas received from the DRI furnace. The CCR thus enables production of syngas in a manner that efficiently utilizes carbon-containing streams that otherwise would require additional handling for removal of carbon components. Further reformate processing in a secondary processing unit, such as an OSR, may improve hydrocarbon conversion with relatively low oxygen consumption versus utilization of a secondary processing utilizing oxygen by itself since the oxygen consumption in this process is sub-stoichiometric on the basis of the amount of oxidant required to fully oxidize an amount of fuel (for example to the end products of H₂O and CO₂), such as less than a 1.0 molar ratio of oxidant:fuel. This ensures that in the second process unit, such as an OSR, the oxygen is consumed to near-extinction or to total extinction while a relatively small portion of the hydrocarbon-based fuel may be consumed in the oxidation reaction. As a result, the temperature of the reformate in the secondary processing unit is raised so that a greater amount of any hydrocarbons remaining from the first syngas are converted into syngas products, forming the second syngas. Combination of the first processing unit and the second processing unit may be effective to increase the specialized conversion that occurs in each reformer for both reformers by permitting each to more effectively operate at their specialized reformation conditions versus processing such a reformate stream alone. It is thus possible to provide a syngas to the DRI furnace with defined component ratios that improve decarbonization of the overall process. Although the combination of the first processing unit and the second processing unit may be beneficial in one or more embodiments, as described previously, the second processing unit may be optional, and the first processing unit, such as a CCR, may be effective to provide a syngas stream that is effective as the reducing gas in the DRI furnace without the need of further processing in the second processing unit. Even when the second processing unit is present, syngas from both of the first processing unit and the second processing unit may be combined or used alternatingly as the reducing gas in the DRI furnace.

In one or more embodiments, which may be combined with other embodiments, the syngas introduced to the DRI furnace may be described by a reducing gas potential (“RGP”), which is a ratio given by a defined value. The RGP value may be approximated by the molar ratio of its contents according to Equation 1.

$$RGP = ( moles {H}_{2} + moles CO ) / ( moles {H}_{2} O + moles {CO}_{2} ) \qquad Eq . 1$$

A greater RGP value may provide for an increased quality of the reduced iron-rich product received from the lower section of the DRI furnace. The RGP quality is determined as a molar ratio of the amount of reduced iron received from the DRI furnace relative to the amount of unreduced or partially reduced oxides of iron. The iron oxides particularly may comprise ferrous oxide, which has a molecular formula of FeO, or Wustite, which has a molecular formula of Fe_{(0.947)}O. In one or more embodiments, which may be combined with other embodiments, the iron product received from the DRI furnace may comprise reduced iron at a concentration of about 80 mol % or greater, such as about 85 mol % or greater or such as about 90 mol % or greater, reduced iron relative to any iron oxides remaining in the iron product. Such concentration is stated free of gangue, slag and other collateral material that may be present in the originally introduced iron ore, such as calcium oxide (CaO), silicon dioxide (SiO₂), titanium dioxide (TiO₂), magnesium oxide (MgO), and aluminum oxide (Al₂O₃). The stated purity thus may be on a “gangue-free” basis. In one or more embodiments, which may be combined with other embodiments, the second syngas may have an RPG value according to Eq. 1 in a range that is greater than 2, such as about 3 or greater, such as about 5 or greater, such as about 10 or greater, such as about 15 or greater, or such as about 20 or greater.

The syngas introduced to the DRI furnace has a molar ratio of hydrogen to carbon monoxide (the “H₂:CO molar ratio”) that is within a defined range for achieving a thermal balance in the DRI furnace. The reaction for H₂ reduction of iron oxides to metallic iron is endothermic while the reaction for CO reduction of iron oxides to metallic iron is exothermic. In one or more embodiments, which may be combined with other embodiments, the H₂:CO molar ratio of the second syngas is in a range of from about 0.001 to about 1000, such as from about 0.01 to about 100, such as from about 0.1 to about 10, such as from about 0.2 to about 5, or such as from about 0.5 to about 2. In one or more embodiments, which may be combined with other embodiments, the second syngas comprises CO in a concentration in a range of from about 30 mol % to about 70 mol %, such as from about 35 mol % to about 65 mol %, or such as from about 40 mol % to about 60%. In one or more embodiments, which may be combined with other embodiments, the second syngas comprises H₂ in a concentration in a range of from about 15 mol % to about 65 mol %, such as from about 30 mol % to about 60 mol %, or such as from about 35 mol % to about 55%. In one or more embodiments, which may be combined with other embodiments, the second syngas comprises CO₂ in a concentration in a range of from about 0.1 mol % to about 15 mol %, such as from about 0.5 mol % to about 10 mol %, or such as from about 1 mol % to about 4 mol %. In one or more embodiments, which may be combined with other embodiments, the second syngas has a temperature in a range of from about 800° C. to about 1200° C., such as from about 925° C. to about 1100° C. In one or more embodiments, which may be combined with other embodiments, the second syngas has a pressure in a range of from about 1 bar to about 10 bar, such as from about 1 bar to about 5 bar.

In one or more embodiments, which may be combined with other embodiments, the first processing unit and the second processing unit, such as a CCR and an OSR, respectively, as well as any intervening or related equipment, may be operated at a pressure that is greater than the operational pressure of the DRI furnace. By operating at a greater pressure, there may be no need to compress the produced syngas prior to introduction into the DRI furnace, and the presence of any compressors or pumps between the second processing unit outlet and the DRI furnace inlet may be expressly excluded. A pressure differential between the second syngas stream and the operational pressure of the DRI furnace may vary, and the variance may depend at least in part on the designed operational pressure for the DRI furnace used. For example, a DRI furnace may be configured for operation at pressures in a range of from about atmospheric pressure to about 5 bar (0.5 MPa or Megapascals). The operational pressures of the syngas processing units, such as the first processing and the second processing unit, and the feed lines, such as the second syngas stream, may be configured to operate at a greater pressure than the operating pressure of the DRI furnace. In one or more embodiments, which may be combined with other embodiments, the pressure of the first syngas stream may be significantly greater than the operating pressure of the DRI furnace. In one or more embodiments, which may be combined with other embodiments, the pressure of the second syngas stream may be significantly greater than the operating pressure of the DRI furnace. In one or more embodiments, which may be combined with other embodiments, the pressure differential between the DRI furnace and any one or more of the second syngas stream, the second processing unit, the first syngas stream, and the first processing unit may be in a range of from about 3 bar (0.3 MPa) differential or greater, such as from about 5 bar (0.5 MPa) differential or greater, or such as from about 10 bar (1 MPa) differential or greater. By operating the syngas production units at a greater pressure than the DRI furnace, process intensification may be achieved along with providing for the use of more compact equipment. This contrasts with operating at only a modest pressure differential, which may require large equipment to accommodate the significant flow velocities and pressure drops through the system, particularly through the catalyst beds of the first processing unit and the second processing unit. The iron production plant may include a flow restriction, such as the valve 146 as given in FIG. 1, that is configured to control flow rate and pressure of the reducing gas stream in line 147 before introduction into the DRI furnace 150.

As shown in FIG. 1, in one or more embodiments, which may be combined with other embodiments, a portion of the hydrocarbon fuel alone or the mixed hydrocarbon fuel and reformant in line 137 may bypass the first processing unit 130 by traversing through line 137a to combine with the stream in line 138 or be introduced directly to the second processing unit. The bypass stream, such as the bypass stream in line 137a, may comprise in a range of from about 0 wt % to about 90 wt %, such as from about 15 wt % to about 85 wt %, such as from about 20 wt % to about 80 wt %, such as from about 25 wt % to about 75 wt %, of the total amount of mixed feed that is introduced into the reforming reactors. The remaining amount of the hydrocarbon or the mixed feed is introduced to the first processing unit as described previously. By utilizing the bypass line, the flow volume through the catalyst-filled tubes in the first processing unit may be reduced, which provides the option to use a first processing unit of a comparatively reduced size, which may reduce capital expenses and operating expenses. The second processing unit may then be effective to partially complete, substantially complete, or fully complete, the reforming of the mixed fuel that is present in the bypass line as well as the first syngas stream produced by the first processing unit. “Partially complete” may indicate greater than 0 mol % and less than 95 mol % conversion, “substantially complete” may indicate 95 mol % conversion or greater and less than 99.5 mol % conversion, and “complete” may indicate 99.5 mol % conversion or greater. In one or more embodiments, line 137a may be absent or may be configured so that mass flow or volume flow through line 137a may be zero, such as the line being closed, or near zero under normal operating conditions.

A reducing gas, which may comprise at least a portion of the first syngas stream received from the first processing unit, which may comprise at least a portion of the second syngas stream from the second processing unit, or which may comprise at least a portion of each of the first syngas stream and the second syngas stream is introduced to the DRI furnace, where a raw iron material is converted to metallic iron. Iron ore pellets comprising ferric oxide (Fe₂O₃) flowing downwardly through the DRI furnace react with the first syngas, the second syngas, or combinations thereof. The syngas functions as a reducing agent to directly remove oxygen from the iron ore pellets and form metallic iron. The oxygen atoms in the Fe₂O₃ transfer to the reducing gas, thereby oxidizing a portion of the CO and the H₂ in the gas phase to CO₂ and H₂O, respectively, as the Fe₂O₃ in the solid phase is reduced. The reducing gas and the other resultant gases produced in the reactions, such as CO₂ and H₂O, traverse upward through the DRI furnace, potentially entraining an amount of particulates, and pass from an upper section of the DRI furnace as the so-called top gas. The DRI furnace may be operated according to standard methods otherwise known in the industry where a syngas is used for the direct reduction of iron ore, making the one or more embodiment systems and processes suitable for DRI furnace unit retrofitting and upgrading.

In one or more embodiments, which may be combined with other embodiments, the iron production process further may comprise passing a portion of the top gas received from the DRI furnace to the combustor as at least a portion of the fuel for the combustor. The DRI furnace may be operated such that the top gas received from the DRI furnace has a composition that is useful as a fuel for the combustor. In one or more embodiments, which may be combined with other embodiments, the top gas may comprise CO in a concentration in a range of from about 15 mol % to about 60 mol %, such as from about 20 mol % to about 50 mol %, or such as from about 25 mol % to about 40 mol %. In one or more embodiments, which may be combined with other embodiments, the top gas may comprise H₂ in a concentration in a range of from about 15 mol % to about 65 mol %, such as from about 20 mol % to about 50 mol %, or such as from about 20 mol % to about 35 mol %. In one or more embodiments, which may be combined with other embodiments, the top gas may comprise CO₂ in a concentration in a range of from about 10 mol % to about 25 mol %, such as from about 12 mol % to about 20 mol %, or such as from about 14 mol % to about 18 mol %. In one or more embodiments, which may be combined with other embodiments, the top gas passing from the DRI furnace may have a temperature in a range of from about 250° C. to about 950° C. or from about 400° C. to about 800° C. The top gas passing from the DRI furnace may have a pressure in a range of from about 1 bar (0.1 MPa) to about 8 bar (0.8 MPa), such as from about 1 bar (0.1 MPa) to about 2.5 bar (0.25 MPa), or such as from about 1 bar (0.1 MPa) to about 2 bar (0.2 MPa).

In one or more embodiments, which may be combined with other embodiments, the iron production process may further comprise processing the top gas in a top gas cleanup unit to remove one or more impurities from the top gas. As discussed previously, since the top gas may include one or more particulates entrained in the gas as well as sulfur oxides (SOx), nitrogen oxides (NOx), and both metals, especially mercury, and metal oxides that may condense out of the vapor phase as the top gas stream cools, one may find it to be beneficial to process the top gas through a filter or other units to at least remove such particulates and gasified impurities.

The top gas received from the DRI furnace or the gas received from the top gas cleanup unit may be divided so that a first portion of the top gas is passed to the combustor as at least a portion of the fuel for combustion. Other portions of the top gas may be introduced to the first processing unit and optionally to the second processing unit. The allocation of the top gas may be in addition to the hydrocarbon fuel that is introduced to the first processing unit. Recycling of the top gas through one or both first processing unit and the second processing unit for reformation may be beneficial for increasing overall production of syngas as well as to tailor the composition of the syngas to meet the operating requirements of the DRI furnace and the iron ore feed being processed.

At least a portion of the top gas is introduced to the combustor to achieve a carbon mass balance in the iron production plant. Combustion of a portion of the top gas in the combustor may be useful to generate the process heat to the first processing unit. An amount of natural gas or other fuel may be used to co-fire the combustor along with the portion of top gas. Fuel use to co-fire may be a “trim fuel” that is useful to maintain a stable flame or is useful to control the temperature of the exhaust stream received from the combustor. The use of such trim fuel may be minimized in the interests of thermal efficiency, although a greater amount of trim fuel may be used during startup of the iron production plant or specific components thereof. It may be preferred to operate the combustor and the first processing unit so that heat available in the exhaust stream from the combustor is converted to process heat in the first processing unit for reforming with a high efficiency. In one or more embodiments, which may be combined with other embodiments, a portion of the heat in the exhaust stream from the combustor may be utilized for heating one or more further streams or components in the iron production plant beyond use in the first processing unit.

After the exhaust gas comprising predominately CO₂ has been passed through the first processing unit as a heating stream, the temperature-reduced heating stream may be introduced to the heating stream processing unit. In the heating stream processing unit, at least water may be removed from the heating fluid stream comprising predominately CO₂. In one or more embodiments, which may be combined with other embodiments, the heating stream processing unit provides an outlet stream that is a substantially pure stream of CO₂ as a product. This stream of substantially pure CO₂ is suitable as a product, such as for sequestration, chemical processes, or enhanced oil recovery (EOR). In one or more embodiments, which may be combined with other embodiments, a portion of the CO₂ is recycled to the combustor for use as a diluent. In one or more embodiments, which may be combined with other embodiments, heat from the temperature-reduced stream of predominately CO₂ that is received from the first processing unit may be recuperated for other uses, such as production of steam, such as high pressure steam, intermediate pressure steam, low pressure steam, or saturated steam, or for the production of boiler feed or condensate water. One or more of these streams may be used, for example, as a working fluid for an associated power production turbine. Such steam may be used in some instances as part of an integrated steelmaking process utilizing the metallic iron received from the DRI furnace.

As discussed previously, the stream of predominately CO₂ introduced to the heating stream processing unit may be partitioned into two or more portions. One or more of the portions may be passed directly to the combustor as a recycle stream without cooling the stream to a temperature of less than the saturation point of water in the stream. One or more of the portions may be separately cooled to a temperature of less than the saturation point of water in the stream using a cooler, effectively dewatering the stream. One or both of the separate portions may be pressurized, such as by passage through one or more compressors or pumps. In the alternative, the stream of predominately CO₂ introduced to the heating stream processing unit may be cooled to less than the temperature of the saturation point of water in the stream using a cooler, and the cooled and dewatered stream may be compressed and its pressure elevated. The compressed stream of CO₂ may then be divided into separate portions, which may be independently passed to the combustor or provided as the CO₂ product.

Prophetic examples of embodiments of the process, which may be combined with other embodiments, were simulated in the ASPEN process simulator (Aspen Technology, Bedford, MA). The results of the simulation are summarized in the Table following, wherein “GJ” is gigajoules, “MT” is million tonnes, with a “tonne” meaning 1000 kilograms (or one metric ton), and “KWH” is kilowatt hours.

| | | Values for | Values for |
|---|---|---|---|
| | | Case 1 (per | Case 2 (per |
| | | tonne of | tonne of |
| Property | Units | DRI product) | DRI product) |
| Natural Gas, LHV, | GJ/MT | 7.70 | 7.67 |
| Oxygen, 99.5% | MT/MT | 0.22 | 0.22 |
| Iron Ore | MT/MT | 1.39 | 1.39 |
| DRI Purity, mol % Fe | mol % | 91% | 91% |
| Net Power Import | KWH/MT | 227 | 248 |
| H₂/CO of Reducing Gas | mol/mol | 1.17 | 1.57 |
| (H₂ + CO)/(CO₂ + H₂O) | mol/mol | 21.5 | 26.0 |
| CO₂ Capture | | 99% | 99% |

Two cases were modeled, and the two cases differed most significantly in relation to the H₂/CO ratio. This illustrated the flexibility for configuration the present systems and processes. The H₂/CO ratio is particularly important for embodiments where an existing DRI plant may be retrofitted to include the further system components and methods of operation described previously. While both H₂ and CO are effective for reducing iron ore, reduction with H₂ is endothermic while reduction with CO is exothermic. Thus, it is possible according to the present disclosure to modify an existing DRI plant to achieve decarbonization of the existing DRI plant since one may match the process thermodynamics of the existing DRI plant through control of the H₂/CO ratio of the present systems and processes. When an existing DRI plant is desired to be decarbonized, it may be beneficial to leave the expensive DRI furnace as is. Since the top gas from the DRI furnace is where all the carbon ends up anyway, it may be suitable according to one or more embodiments of the present disclosure to only retrofit the top gas handling portions of the existing DRI plant. The top gas may be combusted in the oxy-combustor as described previously, and the heat of combustion may be utilized to its maximum benefit in reforming a portion of the hydrocarbon feed into syngas, which may comprise a portion of the reducing gas feed to the DRI furnace. It is thus desirable to match the compositional characteristics of formed syngas to the existing pre-decarbonization arrangement. Such matching may be achieved by any one or more of: controlling the relative amounts of reforming accomplished in one or both of the first processing unit and the second processing unit; controlling the mass flow or volume flow into one or both of the first processing unit and the second processing unit; and controlling the operating conditions of one or both of the first processing unit and the second processing unit.

The process as described is particularly beneficial in that it may be effective to capture or retain substantially all or all of any CO₂ formed from carbon introduced through any of the streams that are introduced into the iron production plant for processing. CO₂ capture of 99% as provided in the previous Table is considered to indicate retention of substantially all of the CO₂ for production as a product and not as an emission or release into the environment. The process may achieve such results without the use of any solvents, such as amines, that are commonly used in the field of so-called “acid gas removal” scrubbers. Such units are typically included as part of CO₂-producing systems and processes to avoid either or both CO₂ buildup with the system, which may cause detrimental process effects, or to prevent process post-formation emissions or releases of such gases into the atmosphere. The CO₂ formed in the DRI furnace passes from the furnace with the top gas and is processed in the combustor to form the heated stream of predominately CO₂ that is used to provide reaction heating in the first processing unit. Since the stream of predominately CO₂ is thereafter processed in the heating stream processing unit and the purified CO₂ is either recycled back to the combustor or controllably produced as a product stream, the operation of the DRI furnace is effectively decarbonized. Any CO₂ remaining in the syngas that is produced within the first processing unit and the second processing unit as reformate is likewise recirculated back through the system via the top gas, thereby following the aforementioned fluid pathways. Accordingly, the process is configured so that all carbon is ultimately processed through the combustor and is removed as CO₂ product.

As discussed previously, the presently disclosed systems and methods may be configured as a new build or components of the systems and methods may be utilized to retrofit an existing DRI production plant for decarbonization of the existing DRI production process. In one or more embodiments, which may be combined with other embodiments, the present disclosure thus may provide a process for decarbonizing an existing DRI production plant, and likewise may provide a modified, upgraded, or retrofitted DRI production plant that is decarbonized. In one or more embodiments, a process for decarbonizing an existing DRI production plant may comprise: operating a DRI furnace in a DRI production plant so introduced iron ore is reduced to metallic iron using introduced syngas, and a top gas is received from the DRI furnace; combusting at least a portion of the top gas with an oxidant in a combustor to form a combustion product stream comprising predominately carbon dioxide and optionally including water; forming the syngas from a hydrocarbon and a reformant in at least one syngas processing unit using at least a portion of the combustion product stream comprising predominately CO₂ as a heating fluid stream; and producing at least a portion of the CO₂ in the combustion product stream comprising predominately CO₂ received from the at least one syngas processing unit as an exportable CO₂ stream. These process steps may be implemented according to any one or more of the process steps described previously herein. Operating the DRI furnace may include any one or more process features described previously, including features described relative to the top gas cleanup unit. Combusting top gas from the DRI furnace in a combustor may include any one or more combustion process features described previously. Forming the syngas may include any one or more syngas production features described previously, including inclusion and operation of one or both of the first processing unit and the second processing unit. Producing an exportable CO₂ stream may include any one or more of the CO₂ production features described previously, including features described relative to the heating stream processing unit and operation thereof.

The terms “about”, “substantially”, and “generally” as used in this application may indicate that certain recited values or conditions are intended to be read as encompassing the expressly recited value or condition and values that are relatively close thereto or conditions that are recognized as being relatively close thereto. For example, unless otherwise indicated in this application, a value of “about” a certain number or “substantially” or “generally” a certain value or result may indicate the specific number, value, or result as well as numbers, values, or results that vary therefrom by ±10% or less, such as ±5% or less, or such as ±2% or less, or such as or ±1% or less. Similarly, unless otherwise indicated in this application, a condition that substantially exists may indicate the condition is met exactly as described or claimed or is within typical manufacturing tolerances or would appear to meet the required condition upon casual observation even if not perfectly meeting the required condition. In one or more embodiments, the values or conditions may be defined as being express and, as such, the term “about” or “substantially” (and thus the noted variances) may be excluded from the express value. Where a plurality of possible lower end values and a plurality of possible upper end values are provided for a particular parameter, one understands that all possible combinations of values inclusive of any of the lower end values and any of the upper end values are encompassed for describing the parameter. Pressures disclosed in “bar” units are understood to be absolute pressure (“bara”).

1. An iron production plant comprising:
a combustor configured to produce a heated stream of predominately carbon dioxide (CO₂);
a first processing unit that is a CO₂ convective reformer (CCR) arranged to receive the heated stream of predominately CO₂, arranged to separately receive a hydrocarbon and one or more reformants, and configured to provide a first synthesis gas (syngas) stream comprising syngas that is formed in the CCR;
optionally, a second processing unit that is arranged to receive at least a portion of the first syngas stream, that is arranged to separately receive an oxygen containing stream, and that is configured to provide a second syngas stream comprising at least syngas that is formed in the second processing unit; and
a furnace arranged to receive one or more iron oxides, arranged to separately receive a reducing gas stream comprising at least a portion of one or both of the first syngas stream and the second syngas stream, and configured to provide a heated, metallic iron product.

2. The iron production plant of claim 1, where the reformant comprises one or more of CO₂, carbon monoxide (CO), hydrogen gas (H₂), and steam.

3. The iron production plant of claim 1, where the second processing unit is an oxidative reactor.

4. The iron production plant of claim 3, wherein the oxidative reactor comprises one or more of an oxygen secondary reformer (OSR), a partial oxidation (POX) reactor, and a partial combustion unit.

5. The iron production plant of claim 1, where the furnace further is configured to provide a top gas.

6. The iron production plant of claim 5, wherein one or more of the following conditions applies:
the iron production plant further comprises a top gas cleanup unit arranged to receive the top gas;
the combustor is arranged to receive at least a portion of the top gas;
one or both of the CCR and the second processing unit is arranged to receive at least a portion of the top gas.

7. The iron production plant of claim 1, further comprising a heating stream processing unit arranged to receive at least a portion of the heated stream of predominately CO₂ from the CCR.

8. The iron production plant of claim 7, where the combustor is arranged to receive a stream of predominately carbon dioxide from the heating stream processing unit.

9. The iron production plant of claim 7, where the heating stream processing unit comprises a compressor or a pump.

10. The iron production plant of claim 9, where the heating stream processing unit further comprises a cooler.

11. The iron production plant of claim 1, where the second processing unit is present.

12. A process for iron production comprising:
combusting a fuel with an oxidant in a combustor to form a heated stream comprising predominately carbon dioxide (CO₂);
reacting a hydrocarbon with reformant in a CO₂ convective reformer (CCR) that is heated by at least a portion of the stream comprising predominately CO₂ to form syngas and receiving from the CCR a first syngas stream;
optionally introducing at least a portion of the first syngas stream to a second processing unit configured to form additional syngas and provide a second syngas stream;
introducing a reducing gas comprising at least a portion of one or both of the first syngas stream and the second syngas stream to a furnace configured to convert one or more iron oxides into metallic iron.

13. The process of claim 12, further comprising passing a top gas from the furnace to the combustor as at least a portion of the fuel.

14. The process of claim 13, further comprising processing the top gas in a top gas cleanup unit to remove one or more impurities from the top gas.

15. The process of claim 14, where the one or more impurities includes solids.

16. The process of claim 12, further comprising processing at least a portion of the stream comprising predominately CO₂ in a processing unit to modify one or more of a pressure, a temperature, and a water content of the stream comprising predominately CO₂ to provide a processed CO₂ stream.

17. The process of claim 16, where the processing comprises pressurizing at least a portion of the stream comprising predominately CO₂ in one or more compressors or pumps.

18. The process of claim 17, where the processing further comprises cooling at least a portion of the stream comprising predominately CO₂.

19. The process of claim 17, further comprising one or both of:
recycling a portion of the processed CO₂ stream to the combustor; and
receiving at least a portion of the processed CO₂ stream as a CO₂ product.

20. The process of claim 12, including the step of introducing at least a portion of the first syngas stream to a second processing unit configured to form additional syngas and provide a second syngas stream.
